(19) United States
(12) Patent Application Publication
(10) Pub. No.: US 2024/0357421 A1
(43) Pub. Date: Oct. 24, 2024

(54) LORAWAN GATEWAY NETWORK AND METHODS

(71) Applicant: DRYAD NETWORKS GMBH, Eberswalde (DE)

(72) Inventors: Carsten BRINKSCHULTE, Berlin (DE); Daniel HOLLOS, Berlin (DE)

(73) Assignee: DRYAD NETWORKS GMBH, Eberswalde (DE)

(21) Appl. No.: 18/682,440

(22) PCT Filed: Aug. 8, 2022
(86) PCT No.: PCT/EP2022/072240

§ 371 Date: Feb. 9, 2024

(30) Foreign Application Priority Data
Aug. 9, 2021 (DE) 10 2021 120 702.9

(51) Int. Cl. H04W 28/04; H04L 1/1867; H04W 84/04; H04W 88/16

(52) U.S. Cl. CPC H04W 28/04; H04L 1/188; H04W 84/04; H04W 88/16

(57) ABSTRACT

The invention relates to a method for communicating in a LoRaWAN mesh gateway network, wherein the LoRaWAN mesh gateway network has multiple terminals, multiple gateways, and a network server. The LoRaWAN mesh gateway network has a second server suitable for executing server functions of the communication method that are intended for the network server in accordance with the LoRaWAN protocol.

The invention relates to the expansion of a low-energy wide area network, also known as a Low Power Wide Area Network (LPWAN), especially a Long Range Wide Area Network (LoRaWAN), a specification for wireless, battery-operated systems in a regional, national, or even global network. LoRaWAN serves the key requirements of the Internet of Things (IoT), particularly secure bi-directional communication, localization, and mobility. The LoRaWAN specification is a layered protocol (Media Access Control MAC) and is designed for large public networks with a single operator. It is based on Semtech's LoRa modulation scheme and offers seamless collaboration between different systems and technologies without the need for rigid, local, complex installations.

The LoRaWAN network architecture is typically built in a star topology in which gateways act as a transparent bridge that forward messages between terminals and a central network server, terminals, and backend. The gateways are connected to a corresponding network server via a standard IP connection, while the terminals use single-hop wireless communication (LoRa) to one or more gateways. Endpoint communication is typically bi-directional and also supports operations such as multi-cast enabling software upgrade over the air or other means of mass distribution of messages to reduce delivery time via air communication. The communication between gateways and terminals is distributed over different data rates and frequency channels, wherein the selection of the data rate represents a compromise between message duration and communication range. Thanks to the so-called spread spectrum technology, communication at different data rates does not interfere with each other and creates a series of virtual channels that increase the capacity of the respective gateways. LoRaWAN data rates range from 0.3 kbps up to 50 kbps. To maximize the battery life of the entire network capacity and terminals, the LoRaWAN network server manages the RF output and data rate for all terminals individually, using an adaptive data rate scheme. While LoRaWAN defines the communication protocol and system rights for the network, the LoRa layer enables a long-range wireless communication connection. LoRa involves wireless communication with very low power consumption. LoRaWAN refers to a network protocol using LoRa chips for communication and is based on a base station that can monitor eight frequencies with multiple spreading factors with nearly 42 channels. With its star topology (LoRaWAN) and energy-saving signal transmission technology (LoRa), this LoRaWAN network technology is specifically designed for the energy-efficient and secure networking of terminals in the Internet of Things and is particularly suitable for outdoor use.

Said Internet of Things places various demands on the network technology used. The architecture is designed for thousands of nodes of terminals, which can be located far away, in populated or unpopulated areas, and in places that are difficult to access, and includes sensors that monitor water flow or sprinkler systems, as well as consumption meters and much more. To meet the requirements of the outdoor application, battery-operated sensor nodes must safely support terminals and at the same time greatly simplify installation and maintenance so that only radio operation is eligible. Strict power consumption requirements for end node terminals must also be taken into account, since they only have to be operated with a single battery for many years.

LoRa uses particularly low energy and is based on chirp frequency spread modulation according to U.S. Pat. No. 7,791,415 B2. Licenses for use are granted by Semtech, a founding member of the industrial consortium. LoRa uses license-and permit-free radio frequencies in the range below 1 GHz, such as 433 MHz and 868 MHz in Europe or 915 MHz in Australia and North America, allowing a range of more than 10 kilometers in rural areas with the lowest energy consumption. The LoRa technology consists of the physical LoRa protocol and the LoRaWAN protocol, which is defined and managed as the upper network layer by the LoRa Alliance industrial consortium. LoRaWAN networks implement a star-shaped architecture using gateway message packets between the terminals and the central network server. The gateways (also called concentrators or base stations) are connected to the network server via the standard Internet protocol, while the terminals communicate with the respective gateway by radio via LoRa (chirp frequency spread modulation) or FSK (frequency modulation). The radio connection is therefore a single-hop network in which the terminals communicate directly with one or more gateways, which then forward the data traffic to the Internet. Conversely, data traffic from the network server to a terminal is only routed via a gateway. Data communication basically works in both directions, but data traffic from the terminal to the network server is the typical application and the predominant operating mode. By bridging larger distances with very low energy consumption, LoRaWAN is particularly suitable for IoT applications outside of settlements, such as automatic irrigation systems or the measurement of environmental parameters in agriculture.

On the physical level, LoRaWAN, like other wireless protocols for IoT applications, uses spread spectrum modulation. It differs by using an adaptive technique based on chirp signals, as opposed to traditional DSSS (Direct Sequence Scatter Spectrum Signaling). The chirp signals offer a compromise between reception sensitivity and maximum data rate. A chirp signal is a signal that varies in frequency over time. LoRaWAN technology can be implemented cost-effectively because it does not rely on a precise clock source. LoRa's range extends up to 40 kilometers in rural areas. In the city, the advantage is good building penetration, since cellars can also be reached. The current requirement is very low at around 10 nA and 100 nA in sleep mode. This means a battery lifespan of up to 15 years can be achieved.

In addition to the physical layer, LoRa/LoRaWAN defines two additional layers. Layer 2 is the LoRaWAN connection layer, which provides basic message integrity protection based on cyclic redundancy checks and enables basic point-to-point communication. The third layer adds the network protocol function, which is defined by LoRaWAN. The LoRaWAN protocol offers node terminals the opportunity to localize each other or to send or receive data via the Internet using the one gateway (also called a concentrator or base station) to the Internet, in particular into a cloud to a cloud application.

There are various bidirectional variants for the terminals. Class A includes communication using the ALOHA access method. With this procedure, the device sends its generated data packets to the gateway, followed by two download receive windows that can be used to receive data. A new data transfer can only be initiated by the terminal during a new upload. Class B terminals, on the other hand, open download receive windows at specified times. To do this, the terminal receives a time-controlled beacon signal from the gateway. This means that a network server knows when the terminal is ready to receive data. Class C terminals have a permanently open download receive window and are therefore permanently active, but also have increased power consumption.

LoRaWAN defines a star topology network architecture in which all the leaf nodes communicate via the most suitable gateway. These gateways handle routing and, if more than one gateway is within range of a leaf node and the local network is congested, they can also redirect communication to an alternative.

However, some other IoT protocols (e.g. ZigBee or Z-Wave) use so-called mesh network architectures to increase the maximum distance of a terminal leaf node from a gateway.

The terminals in the mesh network forward the messages to each other until they reach a gateway, which transfers the messages to the Internet. Mesh networks program themselves and dynamically adapt to environmental conditions without the need for a master controller or hierarchy. However, in order to be able to forward messages, the terminals of a mesh network must be ready to receive either constantly or at regular intervals and cannot be put into sleep mode for long periods of time. The result is a higher energy requirement of the node terminals for forwarding messages to and from the gateways and a resulting reduction in battery life.

The star network architecture of LoRaWAN, on the other hand, allows the nodes (particularly classes A and B) to enter the energy-saving hibernation state for long periods of time, thereby ensuring that the node's battery is put under as little load as possible and can therefore be operated for several years without having to change the battery. The gateway acts as a bridge between simple protocols optimized for battery life (LoRa/LoRaWAN), which are better suited for resource-limited terminals, and the Internet Protocol (IP), which is used to provide IoT services and applications. After the gateway has received the data packets from the terminal via LoRa/LoRaWAN, it sends them via the Internet Protocol (IP) to a network server, which in turn has interfaces to IoT platforms and applications.

The implementation of a multi-hop radio network in the LoRa terminals, analogous to ZigBee or Z-Wave, such as in the development platforms for LoRa terminals from PyCom (LoPy4 and FiPy), solves the problem of range limitation from the terminal to the gateway in that it forwards the data packets from one terminal to another terminal, but is not compatible with the LoRaWAN specification because these terminals must be equipped with an additional mesh function. Existing LoRaWAN-compatible terminals cannot therefore benefit from this range extension, as they can only contact a gateway directly and are not able to communicate with the gateway indirectly via other terminals.

One approach to implementing a mesh network architecture in the area of WiFi is the 802.11s standard, which defines a deterministic access method for WLAN networks that uses time periods instead of concurrent access to the shared medium. No IP routing protocol is used to find a route between the nodes, but a MAC layer is used to take into account the specific and changing properties of the radio connection. A hybrid wireless mesh protocol developed specifically for mesh is usually used here. The 802.11s standard requires the installation of dozens of access points that are only connected to one another by radio. The rule here is forwarding via multiple access points, also known as multi-hop. In extreme cases, only one of these needs to be connected to a LAN or WAN. Each node can perform one, two, or three different network functions: Mesh points pass data on to the next node, mesh access points exchange data with terminals and mesh point portals form the gateways to the wired network world. For the terminals, the mesh network appears like a simple WLAN. Since the 802.11s standard is defined for WLAN network architectures, this standard cannot be directly applied to LoRaWAN networks, which in turn are based on the LoRa radio standard.

The LoRaWAN architecture, on the other hand, ensures that the battery of the IoT node is put under as little load as possible and can therefore be dimensioned appropriately and predictably for the respective application. The gateway, on the other hand, acts as a bridge between simpler protocols that are more suitable for resource-constrained leaf nodes and the Internet Protocol (IP) used to provide IoT services. The gateways send data packets to a server that has interfaces for IoT platforms and applications.

LoRaWAN uses particularly low energy and is based on chirp frequency spread modulation according to U.S. Pat. No. 7,791,415 B2. It can be particularly beneficial for IoT applications such as consumption measurements, environmental parameter measurements, measurement of energy inputs from traffic control and disaster control.

To connect the terminals and gateways with each other, in contrast to LoRaWAN, mesh networks are used in other IOT (Internet of Things) architectures to exchange data directly with each other across multiple stations (multi-hop) and thus extend the range of the wireless network. The individual nodes of the network form a wireless backbone. The individual devices must be within range of each other. The radio cells must have larger overlaps. This makes mesh networks more susceptible to failure. One solution to this problem is the 802.11s standard, which defines a deterministic access method that uses time periods instead of concurrent access to the shared medium. No IP routing protocol is used to find a route between the nodes, but a MAC layer is used to take into account the specific and changing properties of the radio connection. A hybrid wireless mesh protocol developed specifically for mesh is used here. The 802.11s standard requires the installation of dozens of access points that are only connected to one another by radio. The rule here is forwarding via multiple access points, also known as multi-hop. In extreme cases, only one of these needs to be connected to a LAN or WAN. Mesh networking is flexible and also allows new access points to be added. Each node can perform one, two, or three different network functions: Mesh points pass data on to the next node, mesh access points exchange data with terminals and mesh point portals form the gateways to the wired network world. For the terminals, the mesh network appears like a simple WLAN.

It is already known that the range of radio networks can be increased through meshed radio networks and in which meshing of the terminals can be achieved, wherein the terminals communicate with each other and simply forward the data to one another without any special hierarchy until one terminal can finally transfer the data to a gateway. With this so-called meshed multi-hop network, the range limitation of a single radio connection can be removed by forwarding the information or data until it reaches the desired recipient.

The implementation of such a meshed multi-hop radio network in the terminals solves the problem of range limitation from the gateway to the terminal by forwarding the data packets from one terminal to another terminal, but is not compatible with the LoRaWAN specification because special one terminals are used here that have an additional meshing function. Therefore, not all standard LoRaWAN-compatible terminals can operate with this range extension, since standard LoRaWAN terminals can only contact a gateway directly. You are not able to communicate directly with other devices. The range extension is therefore not compatible with the LoRaWAN network standard and therefore cannot use the network extension of the meshed terminals.

However, existing LoRaWAN networks also have other undesirable limitations. One such limitation is in particular the use of the standard IP protocol between the gateway and the network server. Especially when used in rural areas where mobile network coverage (3G, 4G/LTE or even 5G) is sparse or non-existent and a wired Internet connection would be too expensive, a gateway often cannot be operated due to lack of an Internet connection. LoRa networks can therefore only be used where the maximum radio range between the Internet-connected gateway and the terminals is not exceeded.

If LoRaWAN networks are expanded with mesh gateways, greater range or area coverage in areas without access to the Internet can be achieved with a LoRaWAN network. All that is required is individual gateways that are connected to the network server via an IP protocol. However, an unlimited network is not possible here either, since according to the LoRaWAN protocol, class A terminals only have two receive windows and therefore the period of time in which they expect a response is limited. If this time is exceeded, a timeout error occurs and communication with at least one terminal breaks down. In addition, the usage times of the terminals are very short, particularly when used off-grid, i. e. without their own power supply.

The object of the invention is therefore to provide a solution for the range restriction from the network server to the terminal, with which existing LoRaWAN-compatible terminals also benefit from an extension of the range without having to implement additional functions in the terminals or being restricted to class C terminals when using the terminals.

It is also an object of the invention to provide a method for communicating in a LoRaWAN mesh gateway network, with which the range restriction from the network server to the terminal is negated and also ensures greater reliability.

To solve this problem, the present invention proposes a method for communicating in a LoRaWAN mesh gateway network, in which the LoRaWAN mesh gateway network has multiple terminals, multiple gateways, and a network server (NS). According to the invention, a second server carries out server functions of the communication method that are actually intended for the network server according to the LoRaWAN protocol. If the LoRaWAN standard is ported to very large networks in which all gateways no longer have a single-hop connection to the network server, but communication takes place via intermediate mesh gateways, there may be long running times for messages between the terminals and the network servers. As a result of these long running times, it can happen that a message from the network server no longer reaches a terminal within the two receive windows defined by the LoRaWAN protocol and a time-out error occurs on the terminal. By taking over the communication functions of the network server through a second server, the delivery times of the messages can be shortened and time-out errors on the terminal can be avoided. The method according to the invention also ensures that the messages from the network server to a terminal are sent correctly to the terminal. The terminal does not have to have a permanently active download receive window and therefore be permanently active, as with a class C terminal, but can also be, for example, a class A or B terminal in accordance with the LoRaWAN specification. Power consumption is greatly reduced and the lifespan of the terminal is therefore increased. In addition, the second server is connected to the application server like the network server. If the network server fails, operation of the LoRaWAN network is ensured.

In a further development of the method according to the invention, the LoRaWAN mesh gateway network has a first gateway and a second gateway, wherein the first gateway does not have a single-hop connection to the network server. The first gateway is advantageously designed as a second server and, in addition to the network server, carries out the server functions of the communication method.

The advantage of using differently equipped gateways lies in the costs. Not all gateways need to have all the features required in the LoRaWAN mesh gateway network. If the respective gateways are only equipped with the functions that they require at their position in the LoRaWAN mesh gateway network, considerable costs can be saved, for example as a result of reduced energy requirements or eliminated hardware.

In another design of the method according to the invention, an encrypted gateway message is generated on the first gateway. Since a time-out error can occur on the terminal if the distance from the terminal to the network server is too long, there is another option to generate an encrypted gateway message directly on the gateway instead of the delayed receipt of a server message from the network server. The encrypted gateway message has the same content and function as the network server message. The encrypted gateway message ensures that a message from the gateway is correctly sent to the terminal and that the terminal accepts this message as a server message in the sense of the communication protocol. The terminal does not have to have a permanently active download receive window and therefore be permanently active, as with a class C terminal, but can also be, for example, a class A or B terminal in accordance with the LoRaWAN specification. Power consumption is greatly reduced and the lifespan of the terminal is increased.

In a further development of the invention, the gateway message is encrypted on the first gateway. This minimizes the time delay and also ensures that a message from the terminal to a gateway is sent correctly to the gateway.

The gateway message has the same content and function as the server message. The encrypted gateway message ensures that a message from the gateway is correctly sent to the terminal and that the terminal accepts this message as a server message in the sense of the communication protocol. The terminal does not have to have a permanently active download receive window and therefore be permanently active, as with a class C terminal, but can also be, for example, a class A or B terminal in accordance with the LoRaWAN specification. Power consumption is reduced and the lifespan of the terminal is therefore increased.

In another design of the invention, the encrypted terminal message is a message to which the terminal expects a response from the network server in accordance with the LoRaWAN protocol. The gateway message is available as an alternative to the server message directly when the terminal expects a server message. In standard LoRaWAN networks, this function is reserved for the network server, but here it is taken over by the gateway itself. Preferably, the gateway closest to the terminal stores the terminal message. By storing the terminal message, the gateway is able to assign the response generated by the network server and then generate a new response with the same content and pass it on to the terminal at the appropriate time. This reduces the length of communication times and thus avoids endless time-out errors on the terminal. By storing the terminal message, the gateway is able to assign the response generated by the network server and then generate a new response with the same content and pass it on to the terminal at the appropriate time.

In another embodiment of the invention, the first gateway forwards the encrypted message to a second gateway and/or the network server. This achieves an extension of the range of LoRaWAN networks by interposing the multi-hop network using gateways and thus maintaining full compatibility with the LoRaWAN specification. At least one gateway communicates with the network server via a standard IP connection and using the LoRaWAN protocol.

In another design of the invention, the encrypted gateway message is sent from the gateway to the terminal. This ensures that the terminal is ready to receive.

In a further development of the invention, the encrypted gateway message is sent from the gateway to the terminal within a receive window of the terminal. This ensures that the terminal is ready to receive.

In another design of the invention, the encrypted gateway message is sent to the terminal and/or the terminal message to the gateway via a single-hop connection. The connection from the terminal to the gateway is a direct connection with just one hop of the data packet (of the encrypted message). The network server can be reached from the terminal via a multi-hop connection. This ensures that the encrypted gateway message is generated on a nearby gateway and reaches the terminal safely within the open receive window.

In a further development according to the invention, the encrypted gateway message is generated and/or sent on the gateway. This likewise ensures that the encrypted gateway message is generated on a nearby gateway and reaches the terminal safely within the open receive window.

In another design of the invention, at least one first gateway communicates with at least one second gateway via a wireless point-to-point connection. The first gateways and the second gateways are connected to each other via a multi-hop mesh network, so that the first gateway does not require a direct connection while communicating with the terminals. This simultaneously expands the range of the LoRaWAN network because the first gateway is connected to the second gateway via the meshed multi-hop network and can therefore forward the data from the terminals to the Internet network server. Optionally, at least one second gateway communicates with the network server IP connection. The use of gateways that are adapted to local needs offers the possibility of saving significant costs, especially in very large LoRaWAN mesh gateway networks.

In a further development of the invention, in the method according to the invention for communication in a LoRaWAN mesh gateway network, an encrypted terminal message generated by the terminal and sent to the gateway is stored on the gateway. The gateway thus knows which encrypted terminal message has so far remained unanswered by the network server and which terminal may be in error mode as a result of a time-out.

In an alternative design of the invention, the encrypted terminal message stored on the gateway is only deleted from the gateway's memory after an encrypted server message assigned to the encrypted terminal message has been sent from the network server to the terminal. The gateway thus knows which encrypted terminal message has so far remained unanswered by the network server and which terminal may be in error mode as a result of a time-out.

In a further development of the invention, in the method according to the invention for communication in a LoRaWAN mesh gateway network, an encrypted server message generated by the network server and sent to the gateway is stored on the gateway. If the gateway were to forward the encrypted server message immediately, the encrypted message would possibly reach the terminal outside of a receive window, i. e. while the terminal is not ready to receive. The terminal would then generate a next time-out error.

In a further development of the method according to the invention, the encrypted server message stored on the gateway is only deleted from the gateway's memory after an encrypted terminal message assigned to the server message has been received by the gateway. In an optional design of the method according to the invention, the encrypted server message stored on the gateway is only deleted from the gateway's memory after the stored encrypted server message has been sent from the gateway to the terminal. Typically, the terminals are configured so that they resend an encrypted terminal message after the time-out error has expired. If, in the meantime, the encrypted server message assigned to the terminal message has arrived and been stored on the gateway, it is retrieved from the memory and sent to the terminal. Only after receiving the new terminal message on the gateway and sending the encrypted server message from the gateway to the terminal is the encrypted server message deleted on the gateway.

In another design of the invention, the encrypted gateway message is sent from the gateway to the terminal within a receive window of the terminal. This ensures that the terminal is ready to receive.

In a further development of the method according to the invention, the receive window of the terminal is a receive window that is generated by repeatedly sending a terminal message to the gateway. After a time-out, a terminal attempts to send the encrypted terminal message again, as a result of which two new receive windows open in accordance with the LoRaWAN protocol in which the terminal is ready to receive.

In a further development of the invention, an encrypted terminal message is repeatedly sent to the gateway after a time-out of the terminal. During the time-out of the terminal, it is not possible to receive messages through the terminal. Therefore, the encrypted server message must be sent after that only to be received by the terminal. In an optional further development, this time-out of the terminal occurred as a result of an unanswered terminal message within the two receive windows defined according to the LoRaWAN protocol.

The messages, commands and functions stored on the gateway or generated by a gateway can include the following MAC commands of the LoRaWAN protocol:
Confirmed Uplink (UL)—best effort.
Confirmed UL—end-to-end confirmation for mission-critical messages.
Downlink (DL)
Confirmed DL
ResetInd, ResetConf (Sec. 5.1).
LinkCheckReq, LinkCheckAns (Sec. 5.2).
RekeyInd, RekeyConf (Sec. 5.10)
Device TimeReq, Device TimeAns (Sec. 5.12)
Join request, join accept (Sec. 6.2.2, 6.2.3)

The object is further achieved using a LoRaWAN mesh gateway network according to the invention. Advantageous embodiments of the invention are set out in the dependent claims.

The LoRaWAN mesh gateway network according to the invention has at least one network server, multiple gateways, and multiple terminals. According to the invention, the LoRaWAN mesh gateway network has a second server that can execute server functions in accordance with the LoRaWAN protocol in parallel to the network server. In particular, the second server is connected to the application server like the network server. If the network server fails, operation of the LoRaWAN network is ensured.

In a further development of the invention, the second server has a sub-server unit that is equipped with a program and/or operating system and/or firmware that is suitable for carrying out functionalities intended for the network server (NS) according to the LoRaWAN protocol.

The sub-server unit is also capable of generating a gateway message. This can be, for example, an ACK signal that is used during data transmission to confirm receipt of a data packet. The gateway message ensures that a message from the terminal to a gateway is correctly sent to the gateway. The terminal does not have to have a permanently active download receive window and therefore be permanently active, as with a class C terminal, but can also be, for example, a class A or B terminal in accordance with the LoRaWAN specification. Power consumption is thus reduced and the lifespan of the terminal is therefore increased.

In another design of the invention, the sub-server unit has a processor and a memory. The processor and memory are standard components and therefore inexpensive to manufacture. The sub-server unit is also equipped with a program and/or operating system and/or firmware that is suitable for carrying out functionalities intended for the network server in accordance with the LoRaWAn protocol.

In an advantageous embodiment of the invention, the LoRaWAN mesh gateway network has different gateway types. The gateway types differ in terms of their communication interfaces for communication with other gateways, a network server, or terminals and the resulting type of communication.

In another embodiment of the invention, the LoRaWAN mesh gateway network has a first gateway and a second gateway. The division of the gateways into first gateways and second gateways significantly expands the range of the LoRaWAN network, wherein LoRaWAN-compatible terminals can still be used, which can be distributed and networked far into impassable areas that cannot be reached with conventional wireless networks.

In an advantageous configuration of the invention, the first gateway is the second server. The first gateway communicates with other gateways as well as with one or more terminals. By sending a gateway message from a first gateway to a terminal, it is ensured, for example, that a message from the terminal to a gateway is correctly sent to the gateway. The terminal does not have to have a permanently active download receive window and therefore be permanently active, as with a class C terminal, but can also be, for example, a class A or B terminal in accordance with the LoRaWAN specification. Power consumption and the operating time of the terminal are thus reduced.

In an advantageous configuration of the invention, the first gateway has the sub-server unit. The sub-server unit has a processor and memory and is also equipped with a program and/or operating system and/or firmware that is suitable for carrying out functionalities intended for the network server in accordance with the LoRaWAn protocol.

In another design of the invention, the first gateway has a first gateway communication interface for communication with a terminal and a second gateway communication interface for communication with another first gateway and/or a second gateway. The first gateways and the second gateways are connected to each other via a multi-hop mesh network by means of the first communication interface, such that the first gateway does not require a direct connection while communicating with the terminals. Terminals are connected directly to a first gateway via a single-hub radio network via the second communication interface.

In another embodiment of the invention, each first gateway is suitable for point-to-point wireless communication with a plurality of terminals using single-hop LoRa or FSK radio using the LoRaWAN protocol. This means that the network according to the invention and its components (gateways, terminals) can be distributed and networked far into impassable areas that cannot be reached with conventional radio networks.

In another design of the invention, the first gateway and the second gateway are combined with a plurality of mesh gateway devices, and at least one of the mesh gateway devices does not have a direct IP connection. The first gateways and the second gateways are connected to each other via a multi-hop mesh network, so that the first gateway does not require a direct connection. The invention enables the range of LoRaWAN networks to be extended by interconnecting a multi-hop network using the first gateways and thus maintaining full compatibility with the LoRaWAN specification.

In another design of the invention, a second gateway is provided for communication with the network server via a standard IP connection and using the LoRaWAN protocol. The network communicates with the network server on a standard IP connection using the LoRaWAN protocol. This increases the range of the network while being compatible with the LoRaWAN protocol.

In another embodiment of the invention, the second gateway has a first gateway communication interface for communication with a network server and a second gateway communication interface for communication with a first gateway. The two gateway communication interfaces differ in terms of their communication interfaces for communication with other gateways, a network server, or terminals and the resulting type of communication.

In another configuration of the invention, the first gateways are each integrated with a second gateway in a mesh gateway. The first gateway and the second gateway are combined in one device. Here, the integrated first gateways communicate with each other using a multi-hub radio network, while at least one integrated second gateway is connected to the network server NS via the standard Internet protocol.

In another embodiment of the invention, the LoRaWAN mesh gateway network is a wireless multi-hop radio network. Gateways are connected to each other via a meshed multi-hop network, so that the first gateway does not require a direct connection while communicating with the terminals. This simultaneously expands the range of the LoRaWAN network because the first gateways are connected to one another via the meshed multi-hop network and can therefore forward the data from the terminals to the Internet network server. This removes the range limitation of the direct connection between the terminal and the gateway provided for by the LoRaWAN standard.

Exemplary embodiments of the LoRaWAN mesh gateway network according to the invention and the method according to the invention for communication in a LoRaWAN mesh gateway network are shown schematically in simplified form in the drawings and are explained in more detail in the following description.

Wherein:

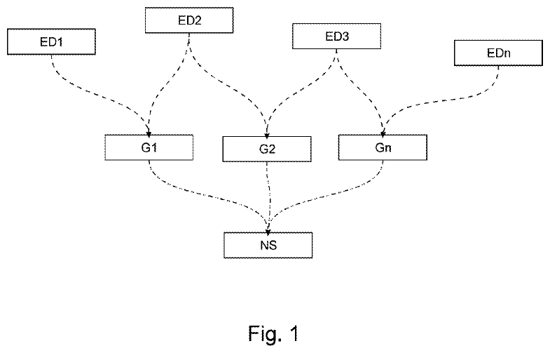

FIG. 1 shows a standard LoRa wireless network

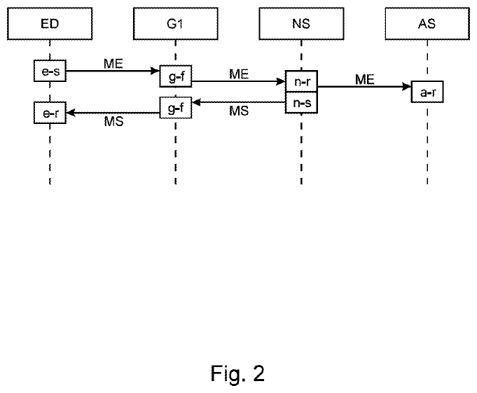

FIG. 2 shows a sequence diagram of the standard LoRa wireless network

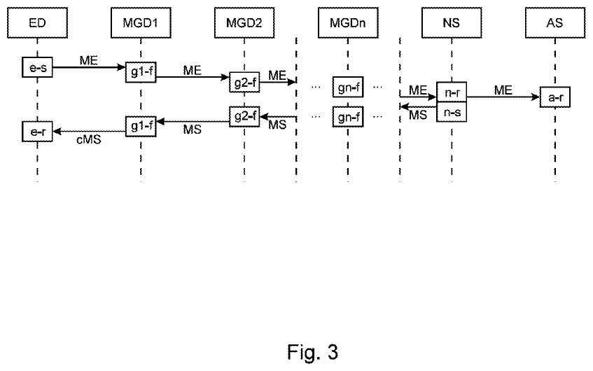

FIG. 3 shows a sequence diagram of the standard LoRaWAN mesh gateway network

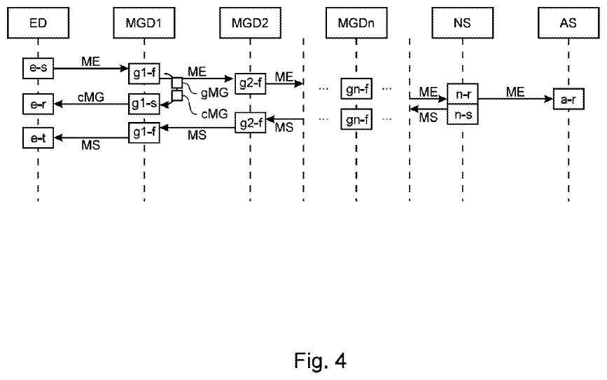

FIG. 4 shows a sequence diagram of the LoRaWAN mesh gateway network with mesh gateways with a sub-server unit-gateway message

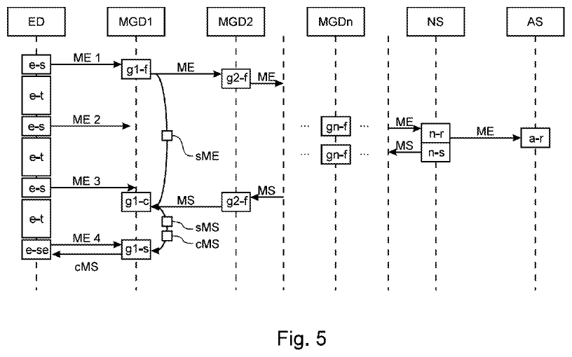

FIG. 5 shows a sequence diagram of the LoRaWAN mesh gateway network with mesh gateways with a sub-server unit-fail-retry

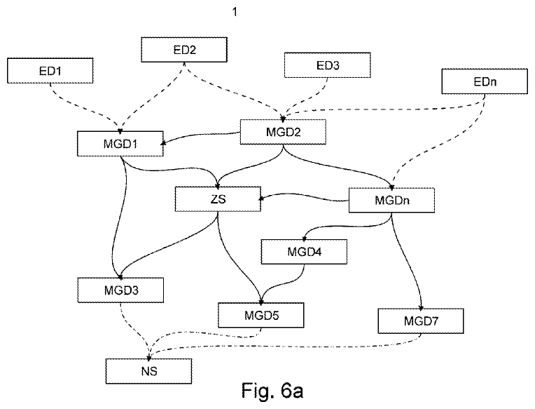

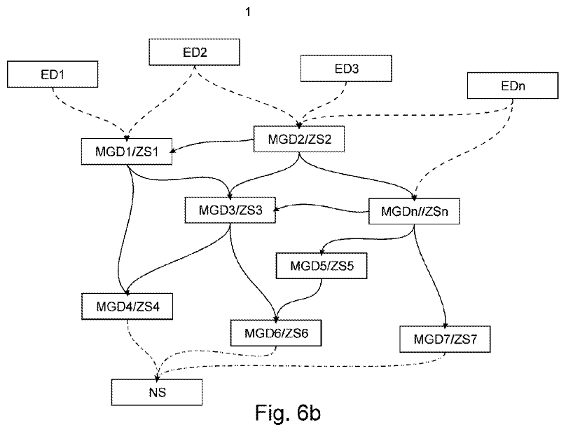

FIG. 6 a shows a LoRaWAN mesh gateway network with terminals, a network server, mesh gateways, and a second server

FIG. 6 b shows a LoRaWAN mesh gateway network with terminals, a network server, mesh gateways and at the same time second servers

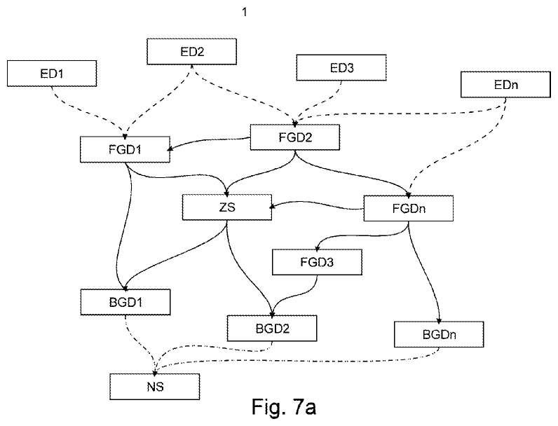

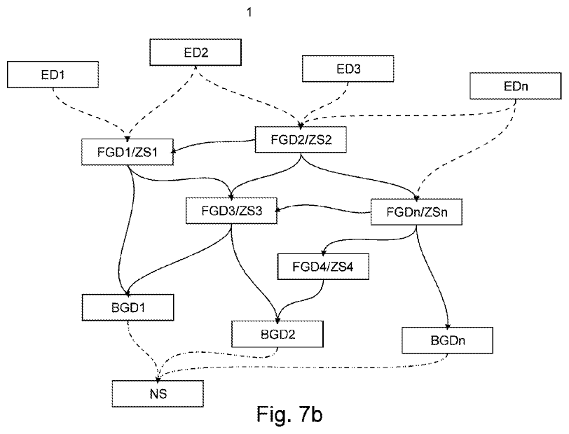

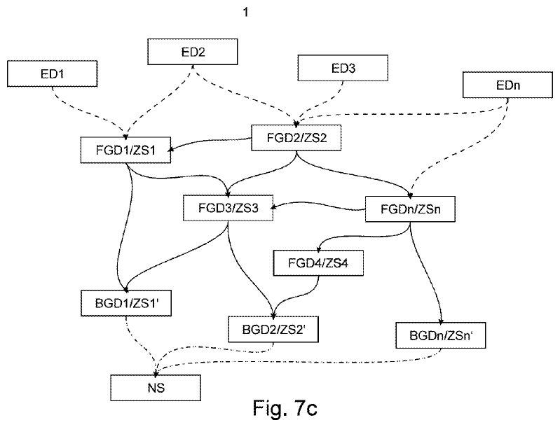

FIG. 7 a shows a LoRaWAN network with terminals, front-end gateways, border gateways, a network server, and a second server

FIG. 7 b shows a LoRaWAN network with terminals, front-end gateways, border gateways, a network server, front-end gateways are also second servers

FIG. 7 c shows a LoRaWAN network with terminals, front-end gateways, border gateways, a network server, front-end gateways and border gateways are also second servers

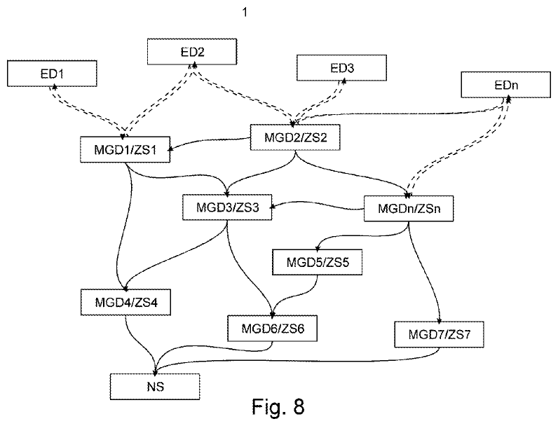

FIG. 8 b shows a LoRaWAN network with terminals, mesh gateways, a network server, mesh gateways are at the same time second servers

FIG. 1 shows a previously known standard LoRa radio network with the typical star topology, in which one or more terminals EDn are connected directly (single hub) via radio to gateways G1, G2, Gn using LoRa modulation or FSK modulation FSK and communicate with the Internet network server NS via the gateways G1, G2, Gn using a standard Internet protocol IP.

FIG. 2 shows a sequence diagram of a known standard LoRaWAN network (see FIG. 1) according to the LoRaWAN protocol. First, a message ME, such as a join request, is sent e-s from a terminal ED to a gateway G1. The gateway G1 forwards g-f this message ME to the network server NS, which on the one hand forwards the message ME to the application server AS and on the other hand generates a response MS a-r which is sent back to the gateway G1 n-s. The gateway G1 in turn forwards g-f this message MS to the terminal ED. In the star architecture of a standard LoRaWAN network (see FIG. 1), this communication occurs very quickly because each terminal ED communicates with the network server NS via a gateway.

FIG. 3 shows a sequence diagram of a LoRaWAN mesh gateway network 1, which no longer has the typical star architecture. Here, multiple mesh gateways MGD1, MGD2, MGDn are arranged between the terminal ED and the network server NS, not all of which have a single-hop connection to the network server NS. A request ME generated by a terminal ED, such as a link check request, must first be forwarded g1-f, g2-f via multiple mesh gateways MGD1, MGD2, MGDn before the request can reach n-r a network server NS. There is a multi-hop connection between some terminals ED and the network server NS. The network server NS forwards n-r this message ME to the application server AS, generates a response message MS and sends it back n-s to the next mesh gateway MGD2. The mesh gateways MGD1, MGD2, MGDn forward g1-f, g2-f the message back to the terminal ED, which receives e-r the response message MS. Advantageously, the response message cMS is encrypted on the mesh gateway MGD1 and sent encrypted in this way to the terminal ED.

Depending on the number of mesh gateways MGD1, MGD2, MGDn via which a message MS is forwarded g1-f, g2-f, gn-f, there is the possibility that the response message MS will no longer be received in time during one of the two receive windows defined according to LoRaWAN at the terminal ED. If there is no response message MS, the terminal ED goes into time-out mode and is only reset after a specific time has elapsed. Since no response message MS is received from the terminal ED, the terminal ED sends the request ME again. The result is an endless loop between sending the request ME and a time-out error on the terminal ED.

FIG. 4 shows a solution for the time-out error mentioned, in which a mesh gateway MGD1, MGD2, MGDn has a sub-server unit that takes over part of the functionality of a network server NS. In this exemplary embodiment, the terminal ED in turn sends e-s a join request ME to the next mesh gateway MGD1. The mesh gateway MGD1 generates gMG and encrypts cMG a response message cMG and sends it back g1-s directly to the terminal ED. The terminal ED receives the response message cMG from the mesh gateway MGD1 within the receive window and remains in proper operation. Parallel to the generating gMG and encrypting cMG of the response message cMG and its sending g1-s to the terminal ED, the mesh gateway MGD1 forwards g1-f the request ME of the terminal ED to the next mesh gateway MGD2. This ensures that a time-out error in the terminal ED is avoided and that the request ME of the terminal ED is forwarded g1-f, g2-f to the network server NS via the mesh gateways MGD1, MGD2, MGDn. According to the LoRaWAN protocol, the network server NS receives the request from the terminal ED, forwards the request to the application server AS n-r and generates n-s a response message MS, which is sent via the forwarding g1-f, g2-f of the mesh gateways MGD1, MGD2, MGDn back to the terminal ED.

FIG. 5 shows a preferred embodiment of the invention. Communication is shown here in an extensive LoRaWAN mesh gateway network, which has a large number of terminals ED as well as mesh gateways MGD1, MGD2, MGDn. At least some mesh gateways MGD1, MGD2, MGDn have a sub-server unit that takes over functionalities of the network server NS.

A terminal ED of the LoRaWAN mesh gateway network sends e-s a message ME1 with a check link request to the network server NS. The message ME1 from the terminal ED is forwarded g1-f, g2-f, gn-f via a large number of mesh gateways MGD1, MGD2, MGDn before the network server NS receives n-r the message ME1. The nearest mesh gateway MGD1 stores sME information about the sent message ME1 of the terminal ED, with the help of which the mesh gateway MGD1 can identify the message ME1. The network server NS forwards the message ME1 to the application server AS and generates a response message MS, which the network server NS sends n-s back to the terminal ED via the plurality of mesh gateways MGD1, MGD2, MGDn.

In the meantime, the receive windows are already closed according to the definition of the LoRaWAN protocol, the ED device is put e-t into time-out mode, etc. After the time-out has expired, the terminal ED again sends e-s a message ME2, which corresponds to the message ME1, to the network server NS. If the terminal ED does not receive a response message MS from the network server NS, the terminal again goes into time-out mode e-t until it can reset itself independently. In this exemplary embodiment, the terminal attempts to send e-s the message ME1, ME2, ME3 three times, without receiving a response message MS from the network server NS by the terminal ED within the respective receive window.

During the third time-out e-t, the response message MS from the network server NS reaches the gateway G1 closest to the terminal ED. The sub-server unit SSE of the mesh gateway MGD1 checks the response message MS of the network server NS and assigns it g1-c based on the information stored about the original message M1 of the terminal ED to identify the message M1 of the original message ME1 of the terminal ED and stores sMS and also encrypts cMS the response message MS from the network server NS. After resetting the terminal ED after the third time-out e-t has elapsed, the terminal ED sends the original message ME4 a fourth time e-se. The nearest mesh gateway MGD1 receives the message ME4, identifies it as identical to the original message ME1 and sends the response message MS received from the network server NS and stored on the mesh gateway MGD1 to the terminal ED. The terminal receives e-se the response message MS from the network server NS and continues normal operation.

FIG. 6 shows an embodiment of the LoRaWAN mesh gateway network 1 according to the invention, in which the first and second gateways Gn (see FIGS. 1, 3) are combined in one device. These so-called mesh gateways MGDn are a combination of a first gateway G1 and a second gateway G2. The mesh gateways MGDn communicate with each other using the multi-hub radio network MHF, and at least one mesh gateway MGDn—in this exemplary embodiment the mesh gateways MGD3, MGD5, MGD7—is connected to the network server NS via the standard Internet protocol IP.

According to the invention, the LoRaWAN mesh gateway network 1 has a second server ZS (FIG. 6 a), which executes the functionalities of the network server NS. In particular, the second server ZS is connected to the application server AS like the network server NS. The second server ZS has a sub-server unit with a processor and storage unit, which sub-server unit is equipped with a program and/or operating system and/or firmware that is suitable for carrying out functionalities intended for the network server NS in accordance with the LoRaWAN protocol.

In a preferred variant of the LoRaWAN mesh gateway network 1 according to the invention, all mesh gateways MGDn have a sub-server unit with a processor and storage unit, which sub-server unit is equipped with a program and/or operating system and/or firmware that is suitable for carrying out the functionalities intended for the network server NS according to the LoRaWAN protocol. All mesh gateways MGDn are at the same time second servers ZSn and connected to the application server AS. The LoRaWAN mesh gateway network 1 according to the invention is therefore designed to be redundant as desired and has a high level of reliability and, in particular, can be expanded as required.

FIG. 7 schematically shows the structure of the components arranged in the LoRaWAN mesh gateway network 1. A terminal EDn has, in addition to the other components that are responsible for the actual function of the terminal, a communication interface only to a gateway FGDn, the connection is wireless via LoRa (chirp frequency spread modulation) or FSK (frequency modulation).

A front-end gateway FGDn has one communication interface to a terminal EDn for data exchange and sending the ACK signal, and one communication interface to a border gateway BGDn. The connection to the border gateway BGDn can in particular take place via a meshed multi-hop network, while the connection to the terminal EDn is a single-hop connection. The two communication interfaces of the front-end gateway FGDn use different communication channels, so that the sender can be mapped via the communication channel used.

A border gateway BGDn has one communication interface to a front-end gateway FGD and one to the network server NS. The border gateway BGDn then sends the data of a terminal EDn, which was sent to the border gateway BGDn via a single-hop and multi-hop connection, directly to the network server NS using an Internet protocol IP. The communication between the border gateway BGD and the network server NS can be wired or wireless. Each communication interface of the border gateway BGD uses its own communication channel that is different from the other communication interfaces.

The second server ZS, which executes the functionalities of the network server NS, can be arranged as an independent device in the LoRaWAN mesh gateway network 1 (FIG. 7 a). At least one front-end gateway FGDn is connected to the second server ZS. The second server ZSn can also be implemented in the front-end gateways FGDn such that the front-end gateways FGDn have a sub-server unit with a processor and storage unit (FIG. 7 b). In the preferred variant (FIG. 7 c) of the LoRaWAN mesh gateway network 1 according to the invention, all front-end gateways FGDn and all border gateway BGDn have a sub-server unit with a processor and storage unit and function as second servers ZSn.

FIG. 8 shows an embodiment of the LoRaWAN mesh gateway network 1 in which front-end gateways FGDn and border gateways BGDn are combined in one device. The mesh gateways MGDn are a combination of the front-end gateways FGDn and the border gateways BGDn (see FIG. 7). The mesh gateways MGDn communicate with each other using the multi-hop radio network MHF, and at least one mesh gateway MGD is connected to the network server NS via the standard Internet protocol IP. A mesh gateway MGDn has an ACK signal generation unit and, after receiving a message from a terminal EDn, sends an ACK signal ACK to the terminal EDn that sent the message. This ensures that a message from the terminal EDn to a mesh gateway MGDn is correctly sent to the mesh gateway MGDn. The terminal does not have to have a permanently active download receive window and therefore be permanently active, as with a class C terminal, but can also be, for example, a class A or B terminal in accordance with the LoRaWAN specification. Power consumption and the operating time of the terminal EDn are thus reduced. Failure of a terminal EDn due to internal errors is avoided.

All mesh gateways MGDn have a sub-server unit with a processor and storage unit, which sub-server unit is equipped with a program and/or operating system and/or firmware that is suitable for carrying out functionalities intended for the network server NS in accordance with the LoRaWAN protocol. All mesh gateways MGDn are at the same time second servers ZSn and connected to the application server AS.

As can be seen from the examples, this type of communication and division of the gateways Gn into first gateways G1n and second gateways G2n significantly expands the LoRaWAN network, wherein LoRaWAN-compatible terminals EDn can still be used, which can be widely distributed and networked in impassable areas that cannot be reached with standard radio networks.

The first gateways G1 and the second gateways G2 are connected to one another via a meshed multi-hub radio network MHD. As a result, the first gateway G1 does not require a direct Internet connection 8 while it communicates with the standard terminals EDn. The range of the LoRaWAN network is significantly expanded because the first gateway G1 is connected to the second gateways G2 via the meshed multi-hub radio network MHF and can forward the data from the terminals EDn to the Internet network server NS. This removes the range limitation of the direct connection between the terminals EDn and the gateways Gn provided for by the LoRaWAN standard.

At the same time, the invention ensures complete compatibility with commercially available LoRa terminals EDn because the first gateway G1 and the standard LoRaWAN radio protocol comply with the standard LoRa radio connection. On the other hand, the second gateway G2 also uses the standard Internet protocol IP for communication with the LoRaWAN network server NS, so that complete compatibility is also achieved on this side. The invention therefore enables the range of LoRaWAN networks to be extended by interposing a multi-hub radio network MHF using first gateways G1 and thereby maintaining full compatibility with the LoRaWAN specification. This type of wireless network is particularly suitable in remote, rural areas where there is neither a wired Internet connection nor suitable mobile network coverage (5G, 4G/LTE, 3G) and thus the star-shaped network topology provided by the LoRa network, wherein the gateway Gn requires a direct Internet connection IP, is not possible.

The invention is not limited to the exemplary embodiments shown, of course. Further designs are possible without departing from the basic idea.

### LIST OF REFERENCE NUMERALS

1 LoRaWAN mesh gateway network
ED, EDn terminals
G, Gn gateways
NS Internet network server
ZS, ZSn, ZS′, ZSn′ second server
AS application server
IP Internet protocol
MHF multi-hub wireless network
MGD mesh gateways
FGD1, FGDn front-end gateway
BGD1, BGDn border gateway
FSK FSK modulation
WN wired connection
e-s sending messages from the terminal
e-r receiving messages from the terminal
e-t time-out error on the terminal
e-se sending and receiving messages from the terminal
gf, g1-f, g2-f, gn-f message forwarding from the gateway
g1-s message sending from the gateway
g1-c message checking from the gateway
n-r message reception on the network server
n-s message sending from the network server
a-r receiving messages on the application server
MG gateway message
gMG generating a gateway message
cMG encrypting a gateway message
sME saving a terminal message
ME terminal message
MS, MS1, MS2, server message
MS3, MS4
cMS encrypting a server message

1. A method for communicating in a LoRaWAN mesh gateway network (1), wherein the LoRaWAN mesh gateway network (1) has multiple terminals (ED), multiple gateways (Gn), and a network server (NS),
characterized in that
a second server (ZS) executes server functions of the communication method that are intended for the network server (NS) according to the LoRaWAN protocol.

2. The method for communicating in a LoRaWAN mesh gateway network (1) according to claim 1,
characterized in that
the LoRaWAN mesh gateway network (1) has a first gateway (G1) and a second gateway (G2),
wherein the first gateway (G1) does not have a single-hop connection to the network server (NS),
wherein the first gateway (G1) is the second server, and the server functions of the communication method are carried out by the first gateway (G1).

3. The method for communicating in a LoRaWAN mesh gateway network (1) according to claim 1,
characterized in that
an encrypted gateway message (cMG) is generated on the first gateway (G1).

4. The method for communicating in a LoRaWAN mesh gateway network (1) according to claim 3,
characterized in that
the encrypted gateway message (cMG) is encrypted on the first gateway (G1).

5. The method for communicating in a LoRaWAN mesh gateway network (1) according to claim 4,
characterized in that
the encrypted terminal message (ME) is a message for which the terminal (ED) expects a response from the network server (NS) in accordance with the LoRaWAN protocol.

6. The method for communicating in a LoRaWAN mesh gateway network (1) according to claim 5,
characterized in that
the encrypted terminal message (ME) is forwarded from the gateway (G1) to the network server (NS) or another gateway (G2, Gn).

7. The method for communicating in a LoRaWAN mesh gateway network (1) according to one or more of claims 3,
characterized in that
the encrypted gateway message (sMG) is sent to the terminal (ED).

8. The method for communicating in a LoRaWAN mesh gateway network (1) according to claim 7,
characterized in that
the encrypted gateway message (sMG) is sent from the gateway (G1) to the terminal (ED) within the receive window defined by the LoRaWAN protocol.

9. The method for communicating in a LoRaWAN mesh gateway network (1) according to one or more of claims 3,
characterized in that
the encrypted gateway message (sMG) is sent to the terminal (ED) and/or the encrypted terminal message (sME) to the gateway (G1) via a single-hop connection.

10. The method for communicating in a LoRaWAN mesh gateway network (1) according to one or more of claims 3,
characterized in that
the encrypted gateway message (sMG) is generated and/or sent by a first gateway (G1).

11. The method for communicating in a LoRaWAN mesh gateway network (1) according to one or more of claims 3,
characterized in that
at least one second gateway (G2) communicates with the network server (NS) using an IP connection.

12. The method for communicating in a LoRaWAN mesh gateway network (1) according to claim 1,
characterized in that
a terminal message (sME) encrypted by a terminal (ED) and sent to the gateway (G1) is stored on the gateway (G1).

13. The method for communicating in a LoRaWAN mesh gateway network (1) according to claim 12,
characterized in that
the encrypted terminal message (sME) stored on the gateway (G1) is only deleted from the memory of the gateway (G1) after an encrypted server message (SMS) assigned to the terminal message (ME) has been sent from the network server (NS) to the terminal (ED).

14. The method for communicating in a LoRaWAN mesh gateway network (1) according to claim 1,
characterized in that
an encrypted server message (sMS) generated by the network server (NS) and sent to the gateway (G1) is stored on the gateway (G1).

15. The method for communicating in a LoRaWAN mesh gateway network (1) according to claim 14,
characterized in that
the encrypted server message (sMS) stored on the gateway (G1) is only deleted from the memory of the gateway (G1) after an encrypted terminal message (sME) assigned to the encrypted server message (sMS) has been received by the gateway (G1).

16. The method for communicating in a LoRaWAN mesh gateway network (1) according to claim 14,
characterized in that
the encrypted server message (MS) stored on the gateway (G1) is only deleted from the memory of the gateway (G1) after the encrypted stored server message (MS) has been sent from the gateway (G1) to the terminal (ED).

17. The method for communicating in a LoRaWAN mesh gateway network (1) according to claim 14,
characterized in that
the encrypted server message (MS) stored on the gateway (G1) is sent from the gateway (G1) to the terminal (ED) within a receive window of the terminal (ED).

18. The method for communicating in a LoRaWAN mesh gateway network (1) according to claim 17,
characterized in that
the receive window of the terminal (ED) is a receive window that is generated by repeatedly sending an encrypted terminal message (ME) to the gateway (G1).

19. The method for communicating in a LoRaWAN mesh gateway network (1) according to claim 18,
characterized in that
the repeated sending of an encrypted terminal message (ME) to the gateway (G1) takes place after a timeout of the terminal (ED).

20. The method for communicating in a LoRaWAN mesh gateway network (1) according to claim 19,
characterized in that
the timeout of the terminal (ED) occurs as a result of an unanswered encrypted terminal message (ME) within the two receive windows defined according to the LoRaWAN protocol.

21. A LoRaWAN mesh gateway network (1) with at least one network server (NS), multiple gateways (Gn), and multiple terminals (EDn),
characterized in that
the LoRaWAN mesh gateway network (1) has a second server (ZS), which is intended and suitable for carrying out functionalities intended for the network server (NS) in parallel with the network server (NS) in accordance with the LoRaWAN protocol.

22. The LoRaWAN mesh gateway network (1) according to claim 21,
characterized in that
the second server (ZS) has a sub-server unit (SSE) which is equipped with a program and/or operating system and/or firmware that is suitable for carrying out functionalities intended for the network server (NS) in accordance with the LoRaWAN protocol.

23. The LoRaWAN mesh gateway network (1) according to claim 22,
characterized in that
the sub-server unit has a memory and/or a processor.

24. The LoRaWAN mesh gateway network (1) according to claim 21,
characterized in that
the LoRaWAN mesh gateway network (1) has different gateway types (Gn).

25. The LoRaWAN mesh gateway network (1) according to claim 24,
characterized in that
the LoRaWAN mesh gateway network (1) has a first gateway (G1) and a second gateway (G2).

26. The LoRaWAN mesh gateway network (1) according to claim 25,
characterized in that
the first gateway (G1) is the second server (ZS).

27. The LoRaWAN mesh gateway network (1) according to claim 26,
characterized in that
the first gateway (G1) has the sub-server unit (SSE).

28. The LoRaWAN mesh gateway network (1) according to claim 25,
characterized in that
the first gateway (G1) has a first gateway communication interface for communication with a terminal (ED) and a second gateway communication interface for communication with another first gateway (G1) and/or a second gateway (G2).

29. The LoRaWAN mesh gateway network (1) according to claim 25,
characterized in that
each first gateway (G1) is suitable for point-to-point wireless communication with a plurality of terminals (EDn) using single-hop LoRa or FSK radio using the LoRaWAN protocol.

30. The LoRaWAN mesh gateway network (1) according to claim 25,
characterized in that
the first gateway (G1) and the second gateway (G2) are combined with a plurality of mesh gateway devices (MGD), and at least one of the mesh gateway devices (MGD) does not have a direct IP connection (IP).

31. The LoRaWAN mesh gateway network (1) according to claim 25,
characterized in that
a second gateway (G2) is provided for communication with the network server (NS) via a standard IP connection (IP) and using the LoRaWAN protocol.

32. The LoRaWAN mesh gateway network (1) according to claim 31,
characterized in that
the second gateway (G2) has a first gateway communication interface for communication with a network server (NS) and a second gateway communication interface for communication with a first gateway (G1).

33. The LoRaWAN mesh gateway network (1) according to claim 25,
characterized in that
the first gateways (G1) are each integrated with a second gateway (G2) in a mesh gateway (MGD).

34. The LoRaWAN mesh gateway network (1) according to claim 21,
characterized in that
the LoRaWAN mesh gateway network (1) is a wireless multi-hop radio network.
